(19) United States
(12) Patent Application Publication
(10) Pub. No.: US 2010/0278214 A1
(43) Pub. Date: Nov. 4, 2010

(54) Pulse-level interleaving for UWB systems

(76) Inventors: Bryan L. Westcott, Rockwall, TX (US); Gerald L. Fudge, Rockwall, TX (US); Mark A. Chivers, McKinney, TX (US); Sujit Ravindran, Dallas, TX (US); Ross A. McClain, JR., Greenville, TX (US); Scott Burkart, (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/387,425

(22) Filed: May 1, 2009

(51) Int. Cl. H04B 1/69

(52) U.S. Cl. 375/130; 375/E01.001

(57) ABSTRACT

Systems and methods are disclosed that provide pulse-level interleaving for multi-pulse-per-bit ultra wideband (UWB) transmit and receive processing techniques to provide significantly improved multi-access for UWB systems and, more particularly, for long range UWB systems. A bit stream is processed such that each bit in a bit stream is represented by a plurality of bits in a bit frame and then transmitted using a plurality of UWB pulses for each bit frame. Where on-off-keying (OOK) modulation is used, each logic “1” is sent out as a plurality of pulses, and each logic “0” is sent out as a plurality of non-pulses. Pulse-level interleaving (PLI) of the pulses across multiple bit frames prior to transmission is provided to allow for improved multi-access (MA) by a plurality of UWB transmitters operating at the same time. Rather than attempt to detect each pulse as it arrives at the receiver, the receiver instead first de-interleaves the pulses and then aggregates the energy from the multiple pulses within each bit frame. The aggregated pulse energy is then processed by a pulse detector to detect a pulse. Where OOK modulation is used, this pulse detection detects the existence of a pulse or the lack of a pulse within the bit frame.

### RELATED APPLICATIONS

This application is related in subject matter to the following concurrently filed applications: U.S. patent application Ser. No. ______, entitled “SYSTEMS AND METHODS FOR RFID TAG OPERATION” by Scott M. Burkart et al.; U.S. patent application Ser. No. ______, entitled “DATA SEPARATION IN HIGH DENSITY ENVIRONMENTS” by Jonathan E. Brown et al.; and U.S. patent application Ser. No. ______, entitled “SYSTEMS AND METHODS FOR GENERATING PULSED OUTPUT SIGNALS USING A GATED RF OSCILLATOR CIRCUIT” by Ross A. McClain et al.; each of which is each hereby incorporated by reference in its entirety.

### TECHNICAL FIELD OF THE INVENTION

This invention relates to receiver and transmitter architectures for efficient wireless communications and, more particularly, to impulse radio receiver and transmitter architectures using ultra-wideband (UWB) pulses to transmit and receive information.

### BACKGROUND

A wide variety of signals and related protocols exist for the use of radio frequency (RF) signals in communication systems and other devices, such as radar systems. One such technique that has received a great deal of recent attention is ultra wideband (UWB) communications. As defined by the FCC (Federal Communications Commission), an ultra-wideband (UWB) signal is an antenna transmission in the range of 3.1 GHz up to 10.6 GHz at a limited transmit power of −41.3 dBm/MHz with an emitted signal bandwidth that exceeds the lesser of 500 MHz or 20% of the center frequency. UWB techniques typically use short-duration wideband pulses for UWB transmission according to the FCC regulations. Impulse radio is a term often used to refer to transmit and receiver operations using these short-duration wideband pulses. UWB signals are currently most often employed for high-bandwidth, short range communications that use high bandwidth radio energy that is pulsed at specific time instants. Other applications have also been proposed, including geographic asset location.

One problem that faces UWB applications, such as geographic asset location applications, is the limited range at which UWB pulse signals can typically be detected. Another problem is the need to distinguish at a receiver multiple UWB transmission sources, for example, where multiple assets are being tracked at the same time. Other problems also exist, including burst transmission or reception errors. With respect to burst transmission or reception errors in RF communication systems, two of the techniques that have been employed in the past are pulse repetition coding (PRC) and bit interleaving.

PRC is technique that is used to repeat data bits so that the loss of a few bits does not lead to the loss of the entire information contained in those bits. For example, if it were desired to send binary data representing “1001,” this could be sent as “11111000000000011111” where each bit is repeated five times. If a burst error of 4 data bits were to occur, it might look something like “111----0000000011111,” where the “-” represents a lost data bit. As can be seen, a receiving device would likely be able to determine that the proper sequence was “1001” because not all data for each bit has been lost.

FIG. 4 (Prior Art) is an example signal diagram 400 for detection of UWB pulses using prior pulse repetition coding (PRC) techniques. The first pulse with the PRC frame 404 represents 1-bit of data 402 that is desired to be transmitted. Rather than send this as a single bit of data, PRC techniques instead are used to modulate this single bit of data to represent it as a plurality of repeated bits. As such, the PRC frame 404 now becomes a plurality of pulses rather then a single pulse 402. The number of repeated bits or pulses can be adjusted, as desired. Once these pulses are received, prior art receiver techniques then use pulse detection circuitry 406 to detect the pulses. As such, if all pulses are detected, then all of the multiple pulses with the PRC frame 404 are detected and output by the pulse detection circuitry 406. The multiple detected pulses are then further processed by circuitry with the receiver.

Bit or data interleaving is a technique that protects from the loss of data bits due to burst receive or transmit errors. For example, if data for the word “TELEPHONE” were to be sent and two letters were lost, then the result might look like “TEL--HONE,” where the “-” represents lost data. The receiver may not be able to determine what the proper word was based upon these errors. However, if the data is first interleaved, for example, “PTHEOLNEE” using an interleaving scheme, then the same error would look like “PTH--LNEE.” De-interleaving the received data, the result would be “T-LEPH-NE.” The receiver may likely be able to determine the proper word once the data is de-interleaved.

FIG. 8 (Prior Art) is data processing diagram 800 for a prior interleaving technique where bits are interleaved prior to being subjected to modulation schemes such as pulse repetition coding (PRC) techniques. As depicted, 4-bits of data 802 are desired to be transmitted. In the example depicted, these bits are “1001.” These bits are then provided to bit interleaving circuitry 804 that operates to interleave or reorder the data bits to produce reordered bits 806. In the example depicted, the data bits have been reordered to be “0110.” The reordered bits 806 can then be subjected to a modulation technique, such as a PRC technique, prior to being transmitted. As depicted, a PRC block 808 operates to repeat each bit that is to be transmitted so as to generate resulting output data 810 that can be transmitted as UWB pulses. As can be seen, each bit has been repeated five times so as to generate a total of 20 bits for the output data 810 from the original 4-bit data 802.

Additional problems are experienced by UWB systems when multiple access is required, such as where one or more receivers are receiving UWB pulses from numerous transmitters operating at the same time. The most common multiple access (MA) methods for UWB are time-hopping UWB (TH-UWB) and direct-sequence UWB (DS-UWB) which pertain to the impulse radio variety of UWB. Direct-sequence spread-spectrum (DS-SS) can also be used for UWB. For impulse radio, a series of short-duration pulses are sent at a regular repetition rate. For TH-UWB and DS-UWB, a multiple access code (typically a pseudorandom sequence or PN code) is applied to those pulses. For TH-UWB, the temporal position of the pulses are perturbed a small amount according to the PN sequence. For DS-UWB, the sign of the pulses are changed according to the PN sequence. The selection of one method over the other depends on the communication channel (e.g., propagation effects, interference and noise), which varies according to the UWB application.

UWB systems may also utilize a variety of different modulation techniques to modulate pulses to encode data. Modulation techniques include phase shift keying (PSK), binary phase shift keying (BPSK), on-off keying (OOK), pulse amplitude modulation (PAM) or pulse position modulation (PPM). If desired, these modulation techniques can also be applied to either TH-UWB or DS-UWB multiple access methods.

While prior efforts have been made to apply various communication techniques including PRC and bit interleaving to UWB communications, improvements are still needed with respect to UWB communications, and particularly with respect to the use of UWB for long range geographic asset location and multi-access receivers tracking multiple UWB transmitters.

### SUMMARY OF THE INVENTION

Systems and methods are disclosed that provide pulse-level interleaving for multi-pulse-per-bit ultra wideband (UWB) transmit and receive processing techniques to provide significantly improved multi-access for UWB systems and, more particularly, for long range UWB systems. A bit stream is processed such that each bit in a bit stream is represented by a plurality of bits in a bit frame and then transmitted using a plurality of UWB pulses for each bit frame. Where on-off-keying (OOK) modulation is used, each logic “1” is sent out as a plurality of pulses, and each logic “0” is sent out as a plurality of non-pulses. Pulse-level interleaving (PLI) of the pulses across multiple bit frames prior to transmission is provided to allow for improved multi-access (MA) by a plurality of UWB transmitters operating at the same time. Rather than attempt to detect each pulse as it arrives at the receiver, the receiver instead first de-interleaves the pulses and then aggregates the energy from the multiple pulses within each bit frame. The aggregated pulse energy is then processed by a pulse detector to detect a pulse. Where OOK modulation is used, this pulse detection detects the existence of a pulse or the lack of a pulse within the bit frame. As described below, other features and variations can be implemented and related methods and systems can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram for a UWB transmitter and receiver that utilize multi-pulse-per-bit processing and communications.

FIG. 2 is a block diagram for a transmit path and a receive path that utilize multi-pulse-per-bit UWB pulse transmissions.

FIG. 3 is a signal diagram for the aggregation of multi-pulse-per-bit pulses prior to detection according to the multi-pulse-per-bit processing described herein.

FIG. 4 (Prior Art) is a signal diagram for detection of pulses using prior pulse repetition coding (PRC) techniques.

FIG. 5 is a block diagram for a UWB transmitter and receiver that utilize multi-pulse-per-bit processing and pulse-level interleaving across multiple bit frames.

FIG. 6 is a block diagram for a transmit path and a receive path that utilize multi-pulse-per-bit processing and pulse-level interleaving across multiple bit frames.

FIG. 7 is a data processing diagram for pulse interleaving across multiple bit frames after multi-pulse-per-bit processing as described herein.

FIG. 8 (Prior Art) is data processing diagram for a prior interleaving technique where bits are interleaved prior to being subjected to modulation schemes such as pulse repetition coding (PRC) techniques.

FIGS. 9A-9E are more detailed signal diagrams for pulse-level interleaving across every two bit frames after multi-pulse-per-bit processing as described herein.

### DETAILED DESCRIPTION OF THE INVENTION

Systems and methods are disclosed that provide pulse-level interleaving for multi-pulse-per-bit ultra wideband (UWB) transmit and receive processing techniques to provide significantly improved multi-access for UWB systems and, more particularly, for long range UWB systems. A bit stream is processed such that each bit in a bit stream is represented by a plurality of bits in a bit frame and then transmitted using a plurality of UWB pulses for each bit frame. Where on-off-keying (OOK) modulation is used, each logic “1” is sent out as a plurality of pulses, and each logic “0” is sent out as a plurality of non-pulses. Pulse-level interleaving (PLI) of the pulses across multiple bit frames prior to transmission is provided to allow for improved multi-access (MA) by a plurality of UWB transmitters operating at the same time. Rather than attempt to detect each pulse as it arrives at the receiver, the receiver instead first de-interleaves the pulses and then aggregates the energy from the multiple pulses within each bit frame. The aggregated pulse energy is then processed by a pulse detector to detect a pulse. Where OOK modulation is used, this pulse detection detects the existence of a pulse or the lack of a pulse within the bit frame. As described below, other features and variations can be implemented and related methods and systems can be utilized, as well.

FIG. 1 is a block diagram for an embodiment 100 including a UWB transmitter 102 and UWB receiver 104 that utilize multi-pulse-per-bit processing and communications. As depicted, the UWB transmitter 104 includes multi-pulse-per-bit processing block 108, which operates to produce multiple UWB pulses for each data bit to be sent out by the UWB transmitter 104 as described in more detail below. The UWB transmitter transmits UWB pulses 110 that are then received by the UWB receiver 102. The UWB receiver 102 in turn includes a multi-pulse-per-bit processing block 106 that aggregates the energy associated with the multiple pulses in each bit frame, as described in more detail below, prior to detection of a received pulse. It is noted that the data bits can be part of a data packet, and data packets can be a any desired number of bits in size (e.g., 256 bit packets). It is further noted that transmitted pulses can be sent periodically within repeating time windows. For example, pulses that are less than 1-3 nanosecond in duration can be used and can be sent every 2 milliseconds.

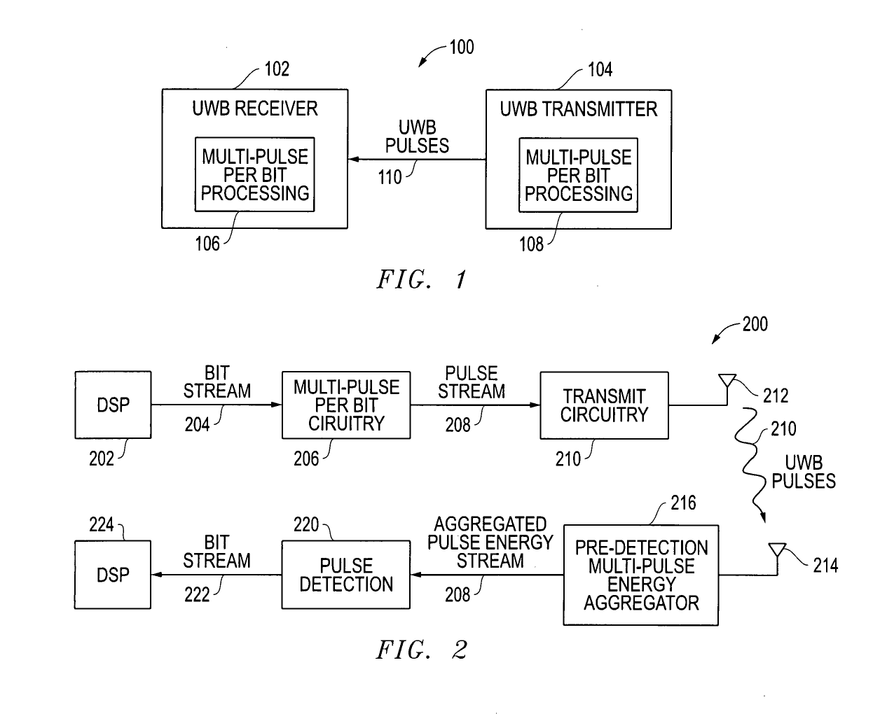

FIG. 2 is a block diagram for an embodiment 200 including a transmit path and a receive path that utilize multi-pulse-per-bit UWB pulse transmissions. Looking first to the transmit path, a digital signal processor (DSP) 202 produces a bit stream 204 that represents data desired to be output by the transmitter. The bit stream 204 is sent to multi-pulse-per-bit circuitry 206, which in turn produces a pulse stream 204 that includes multiple pulses for each data bit within the bit stream 204. Any desired number of multiple pulses can be utilized, for example, twenty (20) pulses per bit can be utilized. The pulse stream 208 is then sent to transmit circuitry 210, which produces the UWB pulses 110 that are transmitted from the transmit antenna 212 and received by the receive antenna 214.

Looking now at the receive path, the UWB pulses received at receive antenna 214 are sent to a pre-detection multi-pulse energy aggregator 216. This energy aggregator 216 operates to aggregate the energy from the multiple pulses for each transmitted bit. For example, if each bit is represented by a bit frame including 20 pulses for each data bit, then the aggregator 216 operates to aggregate the pulse energy received within the bit frame. The output of aggregator 216 is an aggregated pulse energy stream 218. It is this aggregated pulse energy stream 218 that is then provided to pulse detection circuitry 220. The pulse detection circuitry then provides an output bit stream 222 that represents the results of the pulse detection circuitry 220. DSP 224 can then be used to further process this bit stream 222. It is noted that the pre-detection multi-pulse energy aggregator 216 can be implemented using a matched filter that operates to aggregate the pulse energy received over a bit frame.

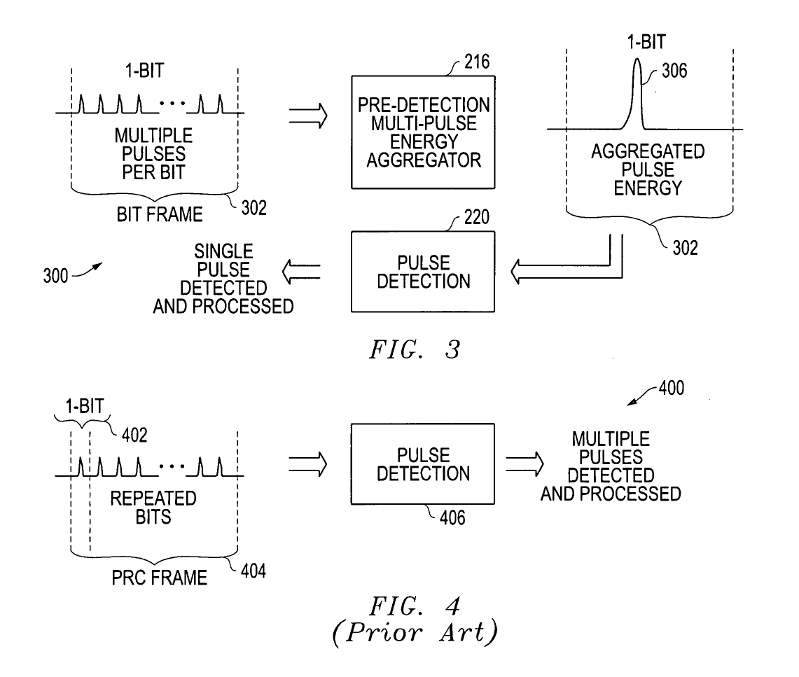

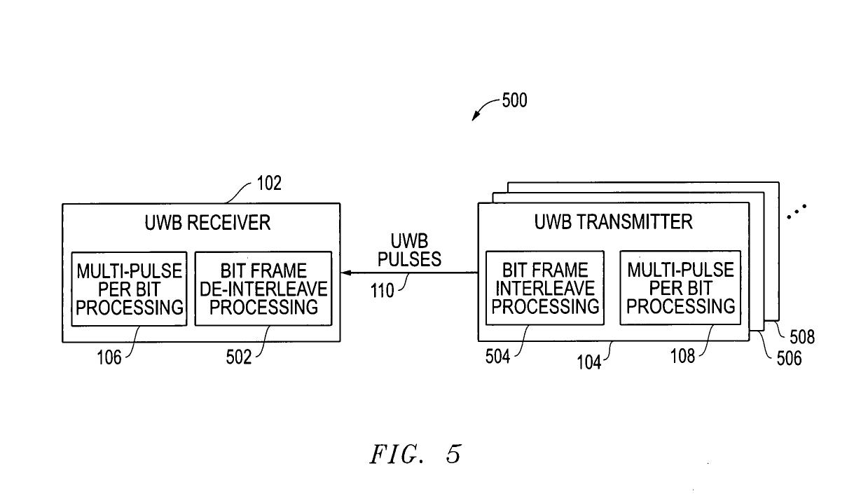

FIG. 3 is a signal flow diagram 300 for the aggregation of multi-pulse-per-bit pulse energy prior to detection according to the multi-pulse-per-bit processing described herein. As depicted a bit frame 302 is being transmitted with multiple pulses representing a single bit of information to be sent. As such, the 1-bit data for the bit frame 302 is sent as multiple pulses per bit. As described above, the pre-detection multi-pulse energy aggregator 216 within the receiver receives and aggregates the pulse energy. The aggregation of pulse energy is represented by aggregated pulse energy 306 that has been aggregated for the transmitted pulses within the bit frame 302. As such, the aggregated pulse energy 306 now represents the 1-bit of data that was transmitted through the multi-pulse-per-bit transmission. The aggregated pulse energy 306 for the bit frame 302 is then sent to the pulse detection circuitry 220 within the receiver. The pulse detection circuitry 220 then detects a single pulse for further processing. As such, a single pulse is detected for the multiple pulses transmitted for the 1-bit of data. It is further noted that if OOK modulation is used, a pulse will be detected when a logic “1” is being sent, and a no pulses will be detected when a logic “0” is being sent.

With respect to the multi-pulse-per-bit embodiments described herein, it is noted that further modulations techniques could be provided for the pulses to be transmitted. For example, the position of the pulses in time can be shifted similar to prior time-hopping (TH) techniques for UWB (TH-UWB). In a basic multi-pulse-per-bit system, each pulse can be transmitted at the same point within a time window for each pulse. For example, a pulse can be sent every 2 milliseconds while each pulse can be 1-3-nanoseconds wide. As such, the time window for each pulse will include a large amount of time where no pulse is being sent. While a nominal position for each pulse can be in the middle of the pulse window, these pulse positions can also be moved in time within the pulse window. For example, if 20 pulses per bit are being utilized for each bit frame, each of these 20 pulses with a bit frame can be moved in time within its respective the pulse window for each pulse according to an offset template that defines a time offset for each pulse with respect to a nominal position within the pulse window. On the receive side, the same offset template and/or an inverted version of the offset template can then be utilized to process the received pulses within the bit frame. If desired, a pseudo-random (PN) code can be used to generate these time offsets for the offset template.

This offset template technique is particularly useful when the multi-pulse-per-bit UWB communication system described herein is applied to an application where multiple transmitters are operating simultaneously to send UWB pulses to the receiver. This multi-access environment can cause problems with the detection of the UWB pulses. If different offset templates are used for different transmitters, then the likelihood that UWB pulses will overlap and interfere can be reduced. The UWB receiver can then utilize the appropriate offset template to align its reception to the pulses received from each transmitter. In this way, improved multi-access can be provided for environments where multiple transmitters are communicating with potentially overlapping UWB pulses transmissions.

As described herein, unique and advantageous pulse-level interleaving (PLI) can be applied to the bit frames at the pulse level to improve reception in multiple access (MA) environments. These unique and advantageous pulse-level interleaving techniques will be described with respect to the example embodiments set forth in further detail below with respect to FIGS. 5, 6, 7 and 9A-E.

This novel pulse-level interleaving multiple access (PLI-MA) technique may applied by a reordering (or interleaving) of PRC-coded pulses across bits, according to a multiple access sequence (e.g., a PN sequence). This pulse-leveling interleaving is similar to both TH-UWB and DS-UWB in that a PN sequence or code is used. However, unlike TH-UWB or DS-UWB, the PN code is applied at the pulse level to interleave pulses prior to transmission. With pulse-level interleaving-based multiple access, the pulses are temporally shifted or hopped in time similar to TH-UWB, although typically by an amount much larger than the pulse repetition period as in TH-UWB. Additionally, the pulse stream after interleaving appears as if data bits have been flipped randomly similar to DS-UWB, even though only a sign change is applied for DS-UWB.

One example of the benefit of this new PLI-MA technique is to produce an output at the transmitter which appears as if a PN sequence was applied to PRC-coded bits before modulation (similar to DS-UWB), while still allowing PRC combining to occur before modulation and detection, and also allowing the use of a non-coherent receiver. It is further noted that interleaving-based multiple access does not increase complexity over TH-UWB or DS-UWB as typical asynchronous implementations require either the buffering of data over the entire multiple access sequence (PN sequence) or the use of a shorter buffer with which to process all parts of the multiple access sequence in parallel. It is also noted that bit-level interleaving, as discussed with respect to FIG. 8 (Prior Art) would not work well as an interleaving method for this environment, nor would the interleaving of pulses related to a single data bit.

In addition to providing a novel and advantageous method for multiple access, the pulse-level interleaving across data bits can potentially provide additional benefits for statistical signal processing (which may be used for detection and demodulation). Temporal variations in the statistics of the channel may occur either due to motion in the environment or a change in interference. A change in interference is particularly problematic for UWB due to the “bursty” nature of UWB packets. A UWB signal-not-of-interest (SNOI) may abruptly begin or end transmission in the middle of the packet of the signal-of-interest (SOI), which produces a temporal variation in the statistics of the channel in the middle of the packet for the SOI. Typically, a training sequence of known data bits is pre-pended to the payload of unknown data bits, in order to provide various estimates of the channel statistics (in addition to performing other functions, such as packet acquisition). The channel estimate from the training sequence may become invalid once a SNOI turns off or on (which may be common in dense radio environments). Pulse-level interleaving across bits helps “spread” any temporal variation across all pulses, thus producing a more statistically stationary channel, at the expense of increasing the number of modes (or local maxima in the probability density function) in the distribution of the channel. It is further noted that bit-level interleaving mitigates the temporal variation problem some, but not as well as pulse-level interleaving across bits, since a single training bit is likely to capture statistics of much more temporal variation with pulse-level interleaving across bits.

For pulse-level interleaving multiple access (PLI-MA) using OOK (on-off keying), all pulse repetitions for a single bit are either “on” or off', thus the pulses may be combined pre-detection, after de-interleaving. Advantageously, this pulse-level interleaving technique does not require modulation of the data being transmitted to allow for multiple access. Rather, it instead modulates the order of the pulses. And PN codes can be used to determine the interleaving. Significantly, this pulse-level interleaving is not the same as simply interleaving the bits, which is often done in communication systems prior to modulation in order to reduce burst errors for error-control coding. The pulse-level interleaving is applied after modulation of the data and is being utilized primarily to provide improved pulse detection from a particular transmitter in a multi-access environment.

At the receiver, the pulse-level interleaving process can be inverted to reproduce the original pulses. For example, where the transmitter applies a PN code to generate the interleaved pulses, the receiver can utilize this same PN code to de-interleave the pulses. Even if using the same PN sequence for interleaving, multiple users will typically not collide unless their packet transmissions happen to be temporally synchronized to within a pulse window. Advantageously, PN-based pulse-level interleaving can provide similar MA performance as coherent reception DS-UWB. Further, the pulse-level interleaving techniques allow for multiple access de-interleaving to occur at the receiver by simply re-ordering the pulses received at the receiver. The de-interleaving process can also occur for multiple users with the same PN sequence by using a buffer at the receiver.

FIG. 5 is a block diagram for an embodiment 500 a UWB transmitter 104 and UWB receiver 102 that utilize multi-pulse-per-bit processing and pulse-level interleaving across multiple bit frames. Embodiment 500 is similar to embodiment 100 of FIG. 1 with the addition of bit frame interleave processing block 504 within the UWB transmitter 104 and the bit frame de-interleave processing block 502 in the UWB receiver 102. The bit frame interleave processing block 504 operates to interleave pulses from multiple bit frames prior to the UWB pulses 110 being transmitted to UWB receiver 102. The bit frame de-interleave processing block 502 then receives the UWB pulses 110 and de-interleaves them to reproduce the original pulses within the bit frames prior to being their being sent to the pre-detection multi-pulse energy aggregator. UWB transmitters 506, 508 . . . represent additional UWB transmitters that create a multi-access environment with respect to receiver 102.

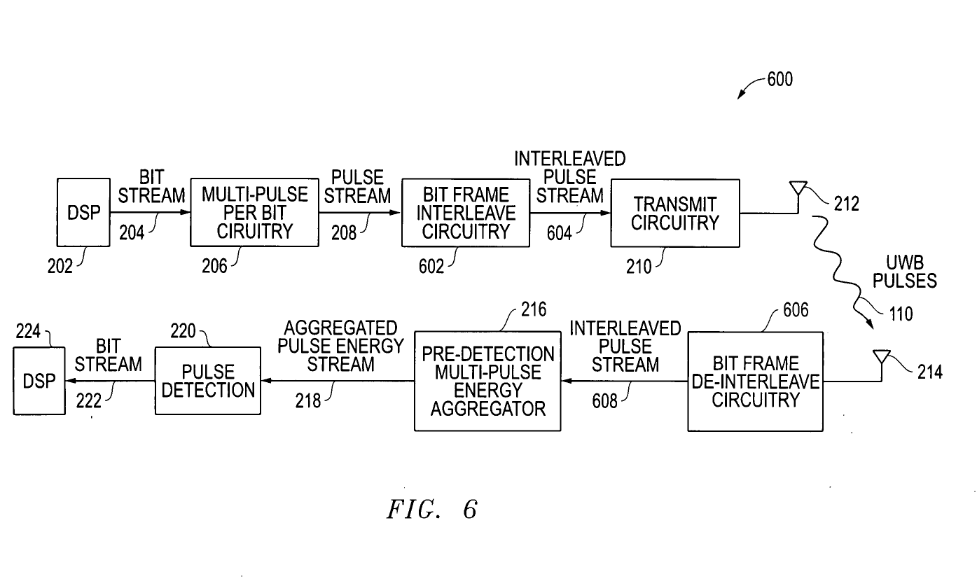

FIG. 6 is a block diagram for an embodiment 600 a transmit path and a receive path that utilize multi-pulse-per-bit processing and pulse-level interleaving across multiple bit frames. The embodiment 600 is similar to embodiment 200 of FIG. 2 with the addition of bit frame interleave circuitry 602 within the transmit path and the addition of bit frame de-interleave circuitry 606 within the receive path. As described above, the pulse stream 208 includes multiple pulses per data bit that are to be transmitted such that each data bit is represented by multiple pulses in a bit frame representing that data bit. The bit frame interleave circuitry 602 interleaves pulses between multiple bit frames to produce an interleaved pulse stream 604 that is sent to transmit circuitry 210. The bit frame de-interleave circuitry 606 receives the interleaved pulse stream through antenna 214 and de-interleaves the interleaved pulse stream to produce a de-interleaved pulse stream 608. After de-interleaving, the de-interleaved pulse stream 608 matches the original pulse stream 208 in FIG. 2.

It is noted that the interleaving and de-interleaving can be implemented using a variety of techniques. One technique for producing the interleaved pulses is to apply a pseudo random (PN) spreading code to multiple bit frames at a time, as indicated above. These PN codes can be applied by the bit frame interleave circuitry 602 across multiple bit frames to produce the interleaved pulse stream 604. And these PN codes can be applied by the bit frame de-interleave circuitry 606 across multiple bit frames to produce the de-interleaved pulse stream 608. It is further noted that the number of bit frames to interleave together can be selected as desired. For example, ten (10) bit frames can be processed or interleaved at a time and then de-interleaved. However, the interleaving process preferably will interleave more than one bit frame of pulses. It is further noted that it is not necessary for the length of the multiple access (PN) sequence be the same as the number of pulses involved in a single interleave, or for the length of the multiple access (PN) sequence to be the same as the number of pulses in a packet. Changes in the length of the multiple access sequence and the number of pulses involved in a single interleave allows the system designer to make tradeoffs in receiver complexity, multiple-access performance, and statistical changes to the received data.

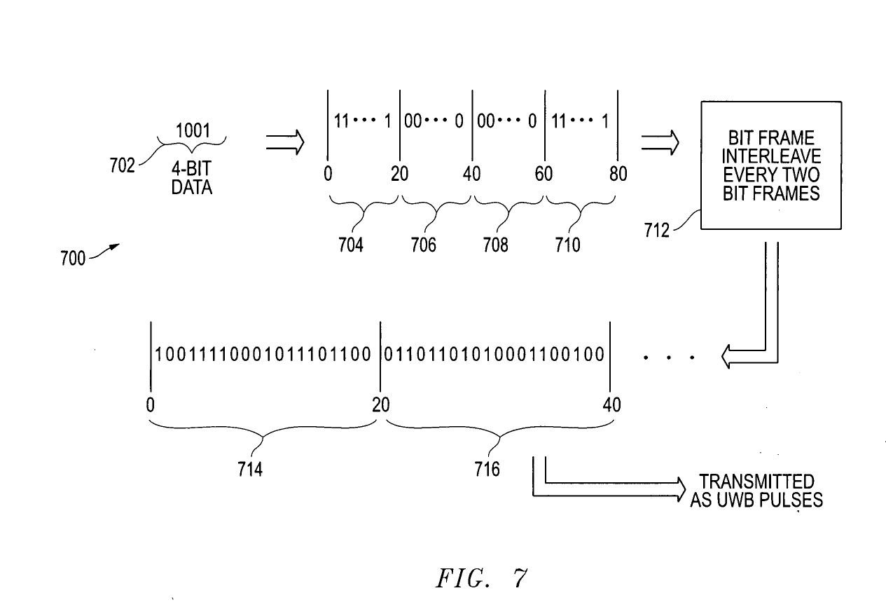

FIG. 7 is a data processing diagram 700 for pulse-level interleaving across multiple bit frames after multi-pulse-per-bit processing as described herein. As depicted, 4-bits of data 702 are desired to be transmitted. In the example depicted, these bits are “1001.” As described above, these bits are provided to multi-pulse-per-bit circuitry that generates multiple pulses for each data bit to be transmitted. In the embodiment 700, the number of pulses used per bit is twenty (20) and on-off keying (OOK) is utilized so that a logic “1” is represented by a pulse and a logic “0” is represented by the absence of a pulse. As depicted, the first bit “1” within the 4-bit data 702 is represented by 20 pulses within bit frame 704 from pulse window 0 to 20. The second bit “0” within the 4-bit data 702 is represented by 20 non-pulses within bit frame 706 from pulse window 21 to 40. The third bit “0” within the 4-bit data 702 is also represented by 20 non-pulses within bit frame 708 from pulse window 41 to 60. And the fourth bit “1” within the 4-bit data 702 is represented by 20 pulses within bit frame 710 from pulse window 61 to 80. The “1” designations within bit frames 704 and 710 represent a pulse. And the “0” designations within bit frames 706 and 708 represent non-pulses.

In the embodiment depicted in FIG. 7, two bit frames are interleaved together. This operation is represented block 712 where bit frame interleaving is done every two bit frames. The result of the interleaving process produces bit frames 714 and 716 that include interleaved pulses. In other words, the 20 pulses within bit frame 704 and the 20 non-pulses within bit frame 706 are interleaved such that the 20 pulses are spread across two bit frames from pulse window 0 to 40 covering bit frame 714 and bit frame 716. This pulse-level interleaving across multiple bit frames are then transmitted as UWB pulses.

As described above, FIG. 8 (Prior Art) is data processing diagram 800 for a prior interleaving technique where bits are interleaved prior to being subjected to modulation schemes such as pulse repetition coding (PRC) techniques. In contrast to the pulse-leveling interleaving of the embodiment 700 of FIG. 7, the embodiment 800 does not interleave at the pulse-level. Rather, bits are interleaved prior to modulation, such as modulation using the PRC block 808.

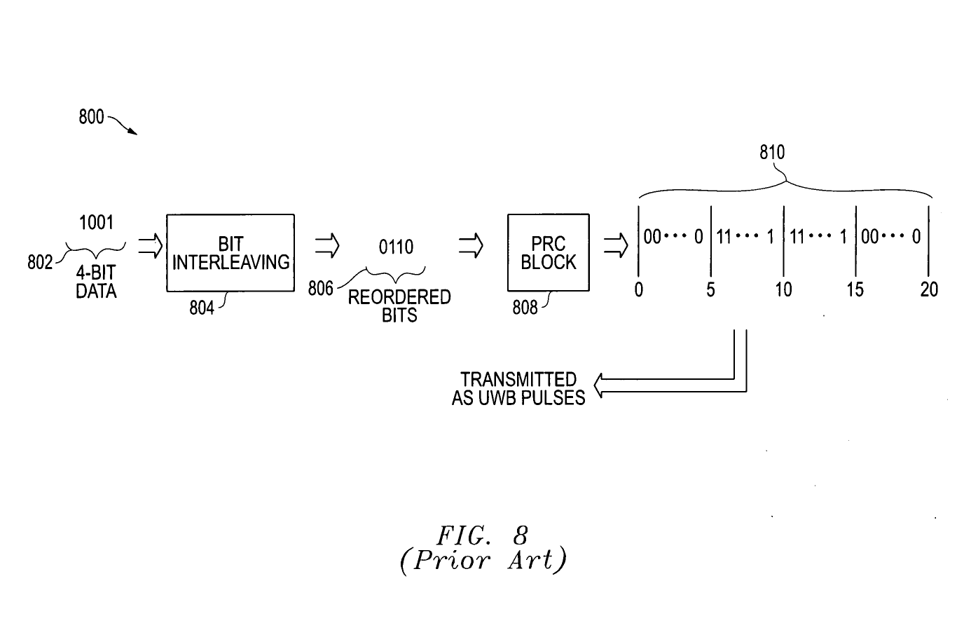

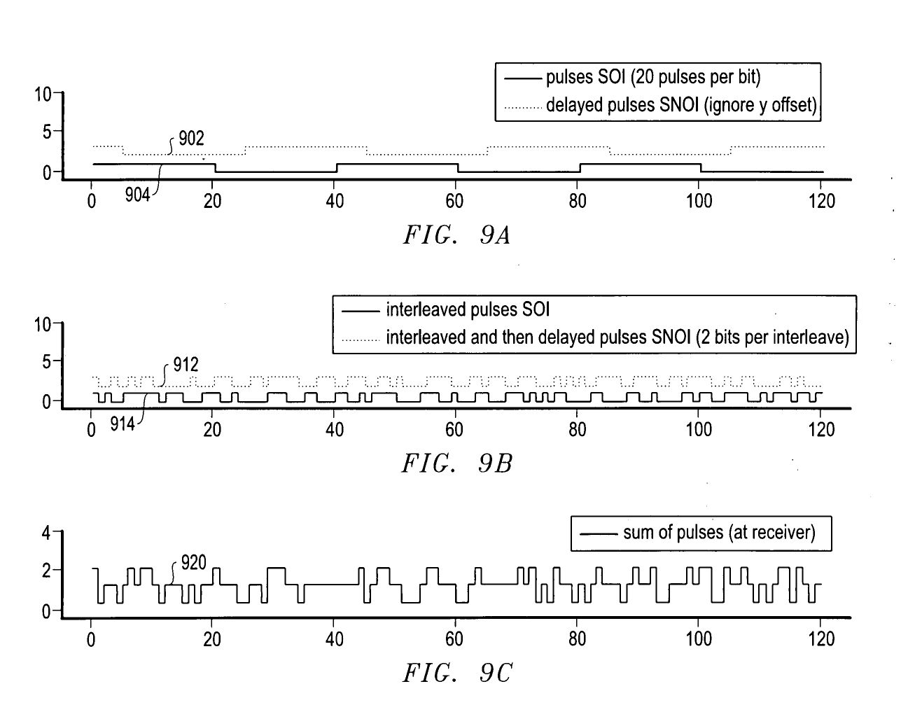

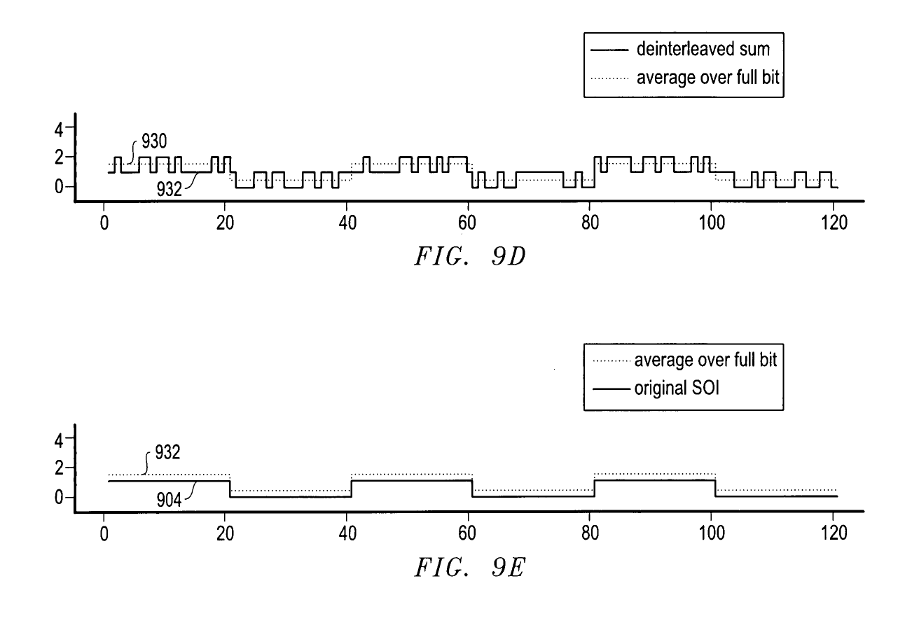

FIGS. 9A-9E are more detailed signal diagrams for pulse-level interleaving across multiple bit frames (e.g., two bit frames in these examples) after multi-pulse-per-bit processing as described herein. For these examples, OOK is being used, similar to the embodiments described above.

FIG. 9A represents UWB transmissions by two transmitters that are overlapping. As depicted, a first signal-of-interest (SOI) 904 is transmitting 20 pulses per bit, and a second signal-not-of-interest (SNOT) is also transmitting 20 pulses per bit. The y-axis represents pulse signal level, and the x-axis represents pulse window number with a bit frame occurring every 20 pulse windows or pulses. The two signal streams are offset on the y-axis so that they can be seen, but it is understood that there levels would actually lie on top of each other. As shown, the pulse signal level is set at a nominal value of 1 using the y-axis scale.

FIG. 9B represents the two pulse signal streams after each has been interleaved. As depicted, 2 data bits are interleaved at a time, which means that 2 bit frames of pulses are interleaved together. The signal stream 912 represents the SNOI signal stream 904 that has been interleaved two bit frames at a time using a first PN code. And the signal 914 represents the SOI signal stream 902 that has been interleaved two bit frames at a time using a second PN code.

FIG. 9C represents the sum 920 of the two pulse streams as seen at the receiver. As shown, the signal levels for the summed signal stream 920 effectively has three levels. A level of 2 is shown where the pulses from interleaved SOI signal stream 914 and interleaved SNOI signal stream 912 overlap with each other. A level of 1 is shown where a pulse from interleaved SOI signal stream 914 or interleaved SNOI signal stream 912 overlap with a non-pulse from the other signal stream. And a level of 0 is shown where non-pulses from interleaved SOI signal stream 914 and interleaved SNOI signal stream 912 overlap with each other.

FIG. 9D represents the result of the de-interleaving process using the first PN code used to interleave the SOI signal stream 904. The signal stream 932 represents the de-interleaved result for the summed signal stream 920. The dotted line 930 represents the average signal strength across each bit frame (i.e., average level from 0-20, 21-40, 41-60 and 61-80).

FIG. 9E represents a comparison of the average signal strength 930 over each bit frame representing each full data bit and the original SOI signal stream 904. As seen, although the levels differ slightly (which is expected since the effects of interference from the SNOI is reduced but not eliminated with asynchronous multiple access techniques), a difference between bit frames having pulses and bit frames having non-pulses in the OOK modulation can readily be determined.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. An ultra wideband (UWB) system utilizing pulse-level interleaving, comprising:
an ultra-wideband (UWB) transmitter configured to apply repetition to data bits to generate bit frames including multiple bits per data bit, to represent the bit frames as pulses, to interleave pulses from multiple bit frames to provide an interleaved pulse stream having pulse-level interleaving, and to transmit the interleaved pulse stream through an antenna; and
an ultra-wideband (UWB) receiver configured to receive the interleaved pulse stream, to de-interleave the interleaved pulse stream to provide a de-interleaved pulse stream including bit frames associated with each data bit, to aggregate pulse energy for each bit frame, and to apply pulse detection to each bit frame to determine the data bit.

2. The UWB system of claim 1, wherein the UWB transmitter is configured to use a pseudo-random (PN) code to interleave the pulses from the plurality of bit frames, and wherein the UWB receiver is configured to use the PN code to de-interleave the pulses among the plurality of bit frames.

3. The UWB system of claim 1, wherein the UWB transmitter is configured to output short-duration wideband pulses that are less than 1-3 nanoseconds in duration.

4. The UWB system of claim 1, wherein the UWB transmitter is configured to use on-off keying (OOK) such that a logic “1” is represented by a plurality of pulses in a bit frame and a logic “0” is represented by a plurality of non-pulses in a bit frame.

5. The UWB system of claim 4, wherein pulses from ten bit frames are interleaved.

6. The UWB system of claim 4, wherein the plurality of pulses or non-pulses within a bit frame for each data bit is twenty.

7. The UWB system of claim 4, further comprising one or more additional UWB transmitters configured to transmit interleaved pulse streams.

8. The UWB system of claim 7, wherein the UWB transmitters are configured to use pseudo-random (PN) codes to interleave the pulses among the plurality of bit frames, and wherein the UWB receiver is configured to use the PN codes to de-interleave the pulses among the plurality of bit frames.

9. The UWB system of claim 8, wherein each UWB transmitter is configured to use different pseudo-random (PN) codes from the other UWB transmitters.

10. The UWB system of claim 1, wherein each data bit is a portion of a data packet to be transmitted.

11. An ultra wideband (UWB) receiver utilizing pulse-level interleaving, comprising:
an antenna configured to receive an interleaved pulse stream from an ultra-wideband (UWB) transmitter, the interleaved pulse stream including pulse-level interleaving representing interleaved pulses from multiple bit frames where each bit frame represents a plurality of bits for a data bit being transmitted;
de-interleave circuitry coupled to receive the interleaved pulse stream and configured to de-interleave the pulses to generate a de-interleaved pulse stream;
pulse energy aggregator circuitry coupled to receive the de-interleaved pulse stream and configured to aggregate pulse energy for each bit frame within the de-interleaved pulse stream to generate an aggregated pulse energy stream; and
pulse detection circuitry configured to receive the aggregated pulse energy stream and to detect whether or not each bit frame contains a pulse.

12. The UWB receiver of claim 11, wherein the interleaved pulse stream includes pulse-level interleaving generated using a pseudo-random (PN) code, and wherein the de-interleave circuitry is configured to use the PN code to de-interleave the interleaved pulse stream.

13. The UWB receiver of claim 12, wherein bit frames are modulated using on-off keying (OOK) such that a logic “1” is represented by a plurality of pulses in a bit frame and a logic “0” is represented by a plurality of non-pulses in a bit frame.

14. The UWB receiver of claim 12, wherein a plurality of interleaved pulse streams are received including interleaving generated using pseudo-random (PN) codes and wherein the de-interleave circuitry is configured to use the pseudo-random (PN) codes to de-interleave the interleaved pulse streams.

15. The UWB receiver of claim 14, wherein the de-interleave circuitry is configured to use a different PN code for each interleaved pulse stream.

16. The UWB receiver of claim 11, wherein the pulse energy aggregator circuitry comprises a match filter.

17. An ultra wideband (UWB) transmitter utilizing pulse-level interleaving, comprising:
multi-pulse-per-bit circuitry configured to receive a bit stream of data bits, to apply repetition to the data bits to provide bit frames including multiple bits per data bit, and to represent the bit frames as pulses to provide a pulse stream including bit frames;
interleave circuitry configured to receive the pulse stream and to interleave pulses from multiple bit frames to provide an interleaved pulse stream having pulse-level interleaving; and
transmit circuitry configured to transmit the interleaved pulse stream as ultra-wideband (UWB) pulses through an antenna.

18. The UWB transmitter of claim 17, wherein the interleave circuitry is configured to use a pseudo-random (PN) code to interleave pulses.

19. The UWB transmitter of claim 18, wherein the multi-pulse-per-bit circuitry is configured to use on-off keying (OOK) such that a logic “1” is represented by a plurality of pulses in a bit frame and a logic “0” is represented by a plurality of non-pulses in a bit frame.

20. The UWB transmitter of claim 18, wherein the interleave circuitry is configured to interleave pulses from ten bit frames.

21. A method for ultra wideband (UWB) transmission and reception utilizing pulse-level interleaving, comprising:
generating a bit stream of data bits to be transmitted;
applying pulse repetition to the data bits to generate a bit frame for each data bit including a plurality of bits for each data bit and representing the bit frames using as pulses;
interleaving pulses within multiple bit frames to provide an interleaved pulse stream having pulse-level interleaving;
transmitting the interleaved pulse stream as an ultra wideband (UWB) pulse transmission;
receiving the interleaved pulse stream;
de-interleaving the interleaved pulse stream to provide a de-interleaved pulse stream;
aggregating pulse energy for each bit frame within the de-interleaved pulse stream; and
detecting whether or not each bit frame contains a pulse using the aggregated pulse energy.

22. The method of claim 21, wherein the interleaving step uses a pseudo-random (PN) code to produce the interleaved pulse stream, and wherein the de-interleaving step uses the PN code to de-interleave the interleaved pulse stream.

23. The method of claim 22, further comprising applying on-off keying (OOK) to the bit frames such that a logic “1” is represented as a plurality of pulses in a bit frame and a logic “0” is represented as a plurality of non-pulses in a bit frame.

24. The method of claim 21, further comprising transmitting a data packet as a plurality of data bits.

25. The method of claim 21, wherein the generating, applying, interleaving and transmitting steps are performed by a plurality ultra wideband (UWB) transmitters, and wherein the receiving, de-interleaving, aggregating and detecting steps are performed by a single ultra wideband (UWB) receiver for each UWB transmitter.

26. The method of claim 25, further comprising adjusting transmit times for the pulses associated with each UWB transmitter by offset amounts prior to the transmitting steps and adjusting pulses received from each UWB transmitter by the offset amounts prior to the aggregating step.

27. The method of claim 25, wherein the interleaving steps utilize pseudo-random (PN) codes to provide the interleaved pulse stream and wherein the de-interleaving steps utilize the PN codes to provide the de-interleaved pulse stream.

28. The method of claim 27, further comprising using different pseudo-random (PN) codes for each of the UWB transmitters.
